(19) United States
(12) Patent Application Publication
(10) Pub. No.: US 2014/0186712 A1
(43) Pub. Date: Jul. 3, 2014

(54) METHOD AND APPARATUS FOR IMPROVING CHARGE ACCEPTANCE OF LEAD-ACID BATTERIES

(71) Applicant: Energy Power Systems LLC, Troy, MI (US)

(72) Inventors: Fabio Albano, Royal Oaks, MI (US); Srinivasan Venkatesan, Bloomfield Hills, MI (US); Subhash Dhar, Bloomfield HIlls, MI (US); William Koetting, Davisburg, MI (US); Susmitha Gopu, Royal Oak, MI (US); Erik W. Anderson, Royal Oak, MI (US); Lin Higley, Troy, MI (US)

(73) Assignee: Energy Power Systems LLC, Troy, MI (US)

(21) Appl. No.: 14/145,640

(22) Filed: Dec. 31, 2013

Related U.S. Application Data
(63) Continuation-in-part of application No. 13/768,192, filed on Feb. 15, 2013.
Application No. 13/768,192 is a continuation of application No. 13/588,623, filed on Aug. 17, 2012.
Application No. 13/588,623 is a continuation-in-part of application No. 13/842,777, filed on Mar. 15, 2013.
Application No. 13/842,777 is a continuation-in-part of application No. 13/475,484, filed on May 18, 2012.

(51) Int. Cl. H01M 4/62; H01M 4/38

(52) U.S. Cl. CPC H01M 4/625; H01M 4/38
USPC 429/225; 252/503

(57) ABSTRACT

An electrode and a lead-acid battery including the same are disclosed. The electrode comprises active material comprising lead and a carbon additive configured to increase a charge input of the lead-acid battery by at least 17%, relative to a negative electrode without the carbon additive.

### RELATED APPLICATIONS

This application is a continuation in part of and claims the benefit of priority to U.S. application Ser. No. 13/768,192, filed Feb. 15, 2013, which is a continuation in part of U.S. application Ser. No. 13/588,623, filed Aug. 17, 2012. This application is a continuation in part of and claims the benefit or priority to U.S. application Ser. No. 13/842,777, filed Mar. 15, 2013, which is a continuation in part of U.S. application Ser. No. 13/475,484, filed May 18, 2012. This application incorporates the disclosure of all of the applications identified above, the entire disclosure of U.S. application Ser. No. 13/350,505, filed Jan. 13, 2012, the entire disclosure of U.S. application Ser. No. 13/843,953, filed Mar. 15, 2013, and the entire disclosure of U.S. application Ser. No. 13/350,686, filed Jan. 13, 2012.

### DESCRIPTION OF THE INVENTION

1. Field of the Invention

This disclosure is related to lead-acid batteries in general and carbon additives for improving charge acceptance of lead-acid batteries in particular.

2. Background of the Invention

Conventional batteries for vehicle applications include flooded Starting-Lighting-Ignition (SLI) batteries and Absorbed Glass Mat (AGM) batteries. A conventional flooded SLI battery is filled with liquid electrolyte in the cell compartments and may require maintenance to ensure proper performance of the batteries. A conventional AGM battery includes porous micro-fiber glass separators that absorb the electrolyte, and does not need maintenance.

In micro-hybrid electric vehicles (HEVs), a battery experiences charge-discharge cycles that are typically very shallow (≦10% depth-of-discharge, DOD). Yet, over time, the accumulated capacity turnover can be substantial. Under these conditions, a conventional flooded SLI battery can withstand an accumulated capacity turnover of about 150 times its nominal capacity. A conventional AGM battery can withstand about 450 capacity turnovers. In both cases, long rest times and insufficient recharge periods result in irreversible sulfation. The dominant failure mode of lead-acid batteries in micro-hybrid applications is sulfation, which causes cyclic capacity fade due to reduced charge acceptance.

Regenerative breaking (REGEN) is an almost universal feature in hybrid-electric vehicles (HEVs) and plug-in hybrid electric vehicles (PHEVs). The electric drive is operated as a generator during deceleration to recharge the battery, hence, the battery is operated at partial state-of-charge (PSOC) to provide significant charge acceptance during REGEN.

For current micro-hybrid vehicles to increase their impact on fuel economy from the current 5-8% to 15-18% improvement, the battery needs to be able to combine the stop/start and REGEN functions more efficiently. Thus, there is a need for a battery that can withstand prolonged operation at PSOC and produce energy throughputs required by HEV and PHEV vehicles. Preferably, batteries for these applications should be able to withstand 8-10% swings in charge/discharge capacity around 50-70% SOC for at least 60,000 cycles with an approximate 4,800 to 6,000 capacity turnovers before experiencing any decay in charge acceptance.

Full recharge or overcharge cycles (reset cycles) are commonly used in the industry to mitigate sulfation issues at PSOC. Micro-hybrid duty cycles, however, offer limited time slots for battery recharging, which are very often interrupted by new discharge periods before full recharge is attained. Moreover, charging times are limited by the passenger driving cycles where the average duration of an urban trip is 30 minutes with a large number of stop/start operations and idle modes. Hence, the battery can rarely achieve a full charge under real-world operating conditions. Another issue with overcharging the batteries to mitigate sulfation is that it promotes hydrogen evolution from the negative plates, causing the batteries to dry out. Thus, there is a need for a more effective solution other than modifying the charging regimen of known batteries.

FIG. 1 illustrates the processes taking place at the negative plate of a lead-acid battery during charge and discharge processes. During discharge, lead sulfate crystals form within the active mass and continue to grow with each partial cycle. During a full charge, the sulfate is reconverted into active mass, i.e., spongy lead (Pb) at the negative electrode and highly porous PbO₂ at the positive electrode. However, there is a size limit to which the sulfate crystals can grow. When the lead sulfate crystals grow to a threshold larger than the pore size, they restrict access to the sulfuric acid, making the process of sulfation irreversible and resulting in permanent loss of capacity and power. Even when the sizes of the crystals are smaller than this threshold, the diffusion rate of the sulfate ions may not keep up with the discharge rate at high current. Hence, keeping the size of lead sulfate crystals small is desirable for improving the fundamental mechanisms of lead-acid batteries.

### SUMMARY OF THE INVENTION

In accordance with the invention, an electrode and a lead-acid battery including the same are disclosed.

According to an embodiment, an electrode comprises active material comprising lead and a carbon additive configured to increase a charge input of the lead-acid battery by at least 17%, relative to a negative electrode without the carbon additive.

According to another embodiment, an electrode comprises active material comprising lead and a carbon additive of at least 1% in weight of the active material.

According to another embodiment, a lead-acid battery comprises a positive electrode and a negative electrode. The negative electrode further comprises active material comprising lead and a carbon additive of at least 1% of the active material in weight.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate embodiments of the invention and together with the description, serve to explain the principles of the invention.

### BRIEF DESCRIPTION OF THE DRAWINGS

FIG. 1 illustrates chemical processes at a negative electrode during charge and discharge of a lead-acid battery.

FIG. 2 illustrates graphical representations of forms and characteristics of carbon additives.

FIG. 3 is a table summarizing characteristics of different embodiments of carbon additives.

FIG. 4 illustrates cyclic voltammograms of different embodiments of carbon additives.

FIG. 5 illustrates comparisons of characteristics of different embodiments of carbon additives.

FIG. 6 illustrates the dynamic charge acceptances of different embodiments of lead-acid batteries with different depths of discharge at 25° C.

FIG. 7 illustrates the dynamic charge acceptances of different embodiments of lead-acid batteries with different depths of discharge at 41° C.

FIG. 8 illustrates the dynamic charge acceptances of different embodiments of lead-acid batteries with carbon additive under different compression levels.

FIG. 9 illustrates the dynamic charge acceptances of different embodiments of lead-acid batteries with second acid fill.

FIG. 10 illustrates the dynamic charge acceptances of different embodiments tested according to the SBA protocol.

FIG. 11 illustrates an embodiment of a cell for a lead-acid battery.

FIG. 12 illustrates changes of charge currents of different embodiments of lead-acid batteries;

FIG. 13 illustrates changes of charge inputs, charge currents, and C rates of different embodiments of lead-acid batteries.

FIG. 14 illustrates changes of charge inputs of different embodiments of lead-acid batteries.

FIG. 15 illustrates changes of charge currents of different embodiments of lead-acid batteries.

FIG. 16 illustrates changes of charge resistances and discharge resistances of different embodiments of lead-acid batteries.

FIG. 17 illustrates changes of average charge resistances and average discharge resistances of different embodiments of lead-acid batteries.

FIG. 18 illustrates changes of charge acceptances of different embodiments of lead-acid batteries as functions of state of charge.

FIG. 19 illustrates changes of charge acceptance of different embodiments of lead-acid batteries as functions of capacity turnover.

FIG. 20 illustrates a top view of a cross-wire structure based on carbon material, according to an embodiment.

FIG. 21 illustrates an angled view of the cross-wire structure of FIG. 20.

FIG. 22 illustrates a top view of a negative and a positive electrodes having carbon material, according to an embodiment.

FIG. 23 illustrates an angled view of the negative and positive electrodes of FIG. 22.

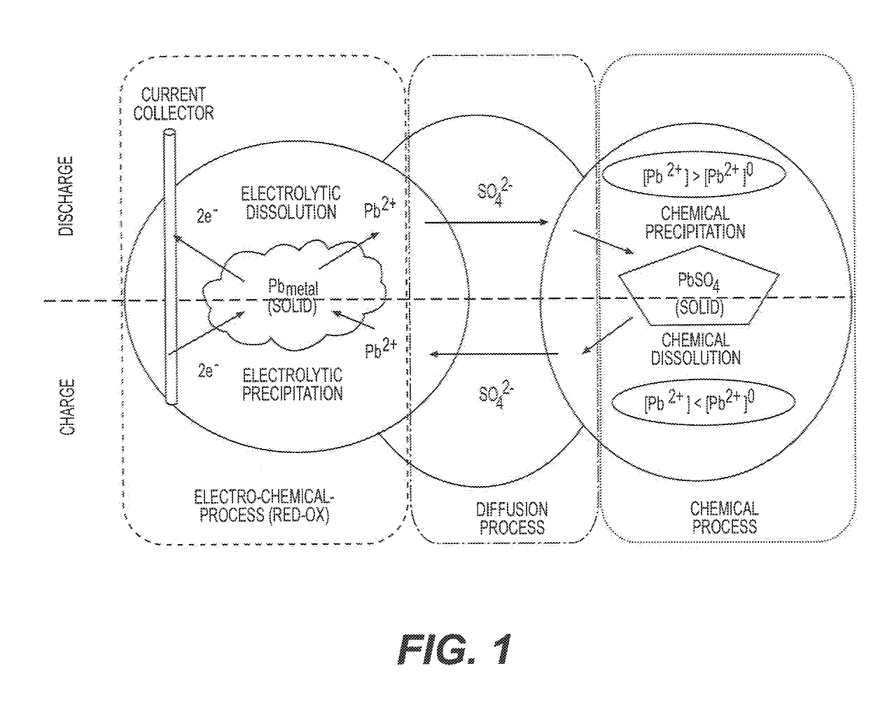

### DESCRIPTION OF THE EMBODIMENTS

Reference will now be made in detail to the exemplary embodiments of the invention, examples of which are illustrated in the accompanying drawings. Wherever possible, the same reference numbers will be used throughout the drawings to refer to the same or like parts.

Three factors, among others, may affect charge acceptance of a lead-acid battery, i.e., the effective amount of charge being accepted by a lead-acid battery during charge. The first factor is related to the age of a battery, i.e., the number of capacity turnovers that the battery has experienced. As the battery is cycled over time, its capacity may fade, and the effective amount of energy input may decline. The second factor is related to the resistance of the battery. Sulfates may grow and accumulate over the cycle life of the battery, increasing the internal resistance of the electrodes and limiting the effective amount of charge that can be accepted by the battery. The third factor is related to the charging protocol. If the voltage limits are setup in a manner that they are reached at an early stage, then the effective amount of charge input may be reduced accordingly.

Dynamic charge acceptance (DCA) can be defined as a ratio between the average amount of current input during a duty cycle I_{recu} (A) and the nominal capacity of the battery Cn (Ah):

$$D C A = \frac{{I}_{recu}}{{C}_{n}} = \frac{\frac{\int I ( t ) d t}{t}}{{C}_{n}} .$$

The amount of charge input may vary according the cycle life and the cycle protocol of the battery. The value is normalized by the capacity in order to make it comparable among batteries of different sizes and so that different charging protocols can be directly compared.

The lead-acid battery disclosed herein may be suitable for vehicle applications. The DCA of the lead-acid battery may be high enough to match any vehicle alternator output, which corresponds to input current pulses of about 10 s at 120˜240 A, i.e., a value greater than or equal to about 2 A/Ah.

According to an embodiment, carbon may be used in a lead-acid battery to reduce sulfation and improve dynamic charge acceptance at a partial state of charge (PSOC). Preferred forms of carbon may include, e.g., carbon blacks, activated carbons, graphitic carbons. These carbon may also be in the form of graphene, carbon nanotubes, fullerenes, double walled carbon nanotubes, carbon fibers, carbon felt, meso-carbon microbeads (MCMB), carbon cones, carbon needles, carbon platelets, carbon nano-belts, carbon nano-wires, or another suitable formulation.

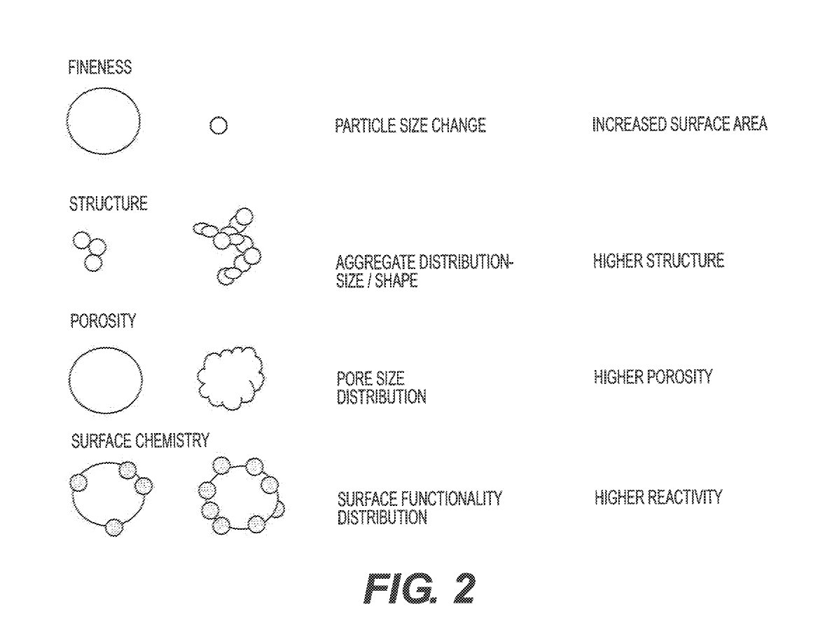

These carbon forms may have different inherent properties, including particle size distribution, aggregates sizes and shapes, specific surface area, electrical conductivity, porosity, surface functionality, and impurities. These properties may improve the charge acceptance of lead-acid batteries. FIG. 2 illustrates schematic representations of these properties of carbon materials relevant to improvement on DCA of lead-acid batteries. According to various embodiments of the present disclosure, carbon or combinations of carbons are used in lead-acid batteries to improve DCA. The mechanisms by which carbon forms may affect charge acceptance in lead-acid batteries are also determined.

In some embodiments, three forms of carbon are respectively added to the electrodes to improve the performance of lead-acid batteries at high rate (i.e., peak power) operation in partial state of charge (HRPSOC). Examples of these carbon forms may include:

Expanded graphites made by Timcal at Strada Industriale, CH-6743 Bodio, Switzerland, and Superior Graphite at 10 South Riverside Plaza, Suite 1470, Chicago, Ill., USA;

Carbon blacks made by Cabot at 157 Concord Road, Billerica, Mass. 01821, USA, and Kuraray at Ote Center Building, 1-1-3, Otemachi, Chiyoda-ku, Tokyo 100-8115, Japan; and

Activated carbons made by EnerG2 at 100 NE Northlake Way, Seattle, Wash. 98105, USA.

One of ordinary skill in the art will recognize that carbon additives other than those listed above may also be used in lead-acid batteries consistent with this disclosure.

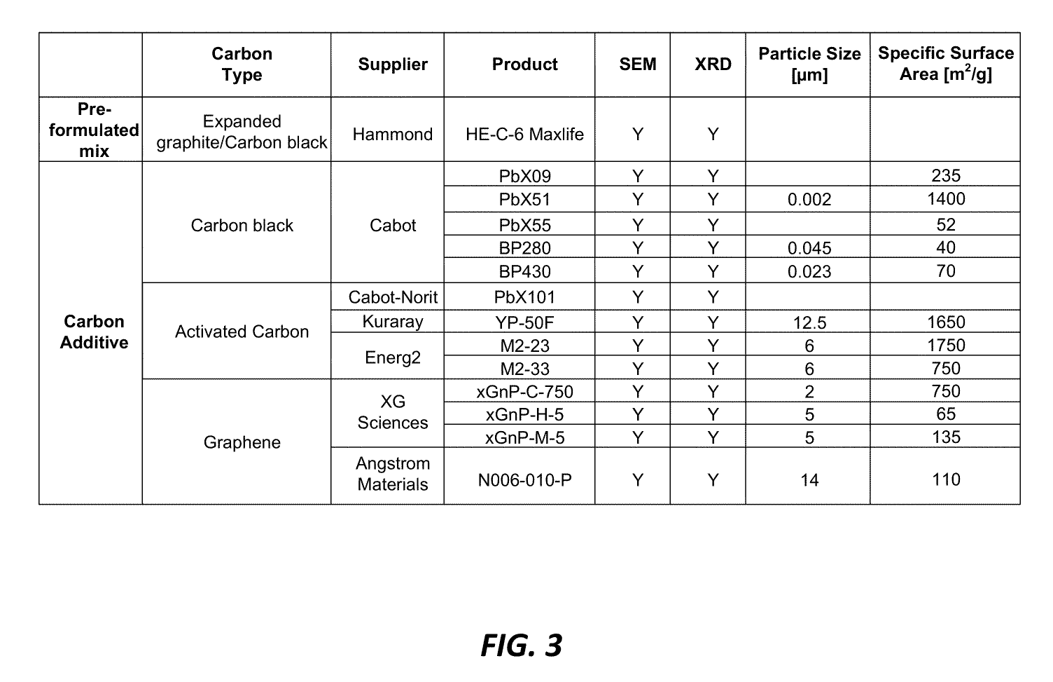

Although these carbon additives are all based on carbon as far as composition and chemistry are concerned, they operate differently in a red-ox environment, such as those in lead-acid batteries. Table 1 in FIG. 3 includes a list of the carbon additives used in the various embodiments in this disclosure and their properties.

To test the certain embodiments of carbon additives, small discs of certain of the carbon powders disclosed above were prepared using a binder and compacted under isostatic compression using a mold. Cyclic voltammetry was then performed on the small discs to identify the onset of hydrogen evolution and the relative kinetics of its evolution in the various materials.

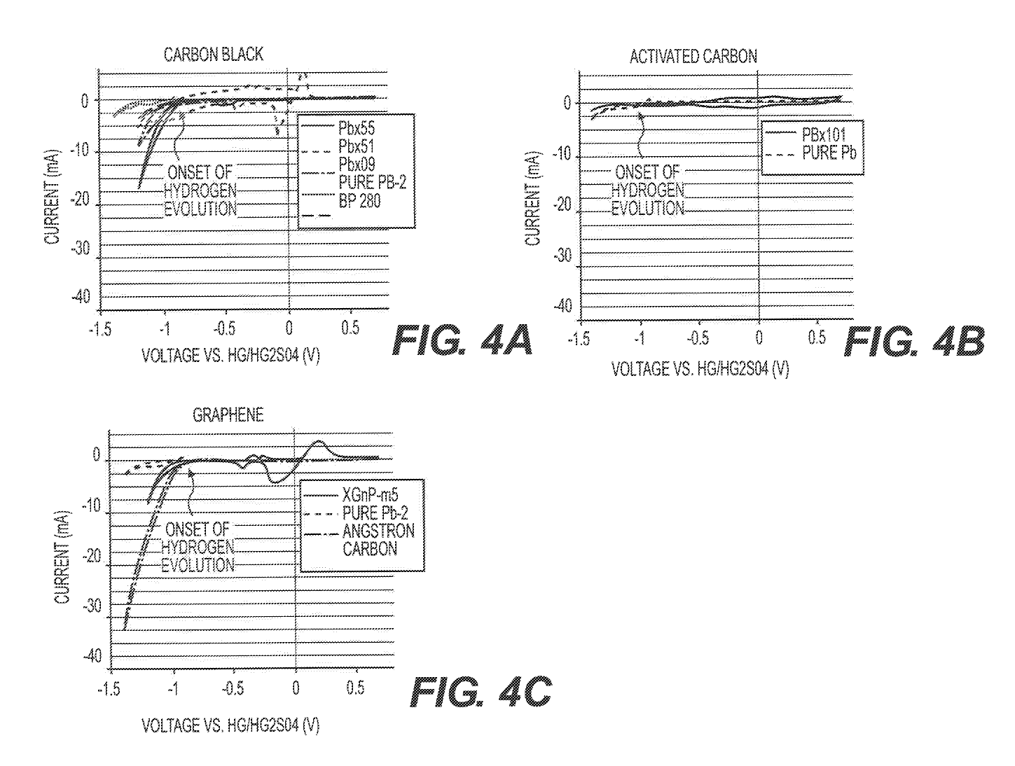

The overpotential for hydrogen evolution on carbon is lower than that on lead and therefore hydrogen evolution is favored when carbon is used in a negative electrode. Thus adding carbon to lead acid chemistry requires special care in managing the hydrogen gas evolution at the negative plate. FIGS. 4a-4c illustrate results from the voltammetry tests conducted to pre-screen suitable carbon compounds, including carbon black (FIG. 4a), activated carbon (FIG. 4b), and graphite (FIG. 4c), according to an embodiment, in order to limit hydrogen evolution due to overpotential favorable conditions.

As shown in in FIGS. 4a-4c, the onset of hydrogen evolution occurs at the interception between the current curves and the X axis. The higher the potential voltage (i.e, less negative or closer to zero Volts) at which the sample curve intersects the zero current line, the more effective the additive. In some embodiments, a small hydride formation peak may occur before the intercept, but the hydrogen evolution regions are a primary concern in these embodiments. The slope of the current rise indicates the rate of hydrogen evolution. Thus, a higher slope corresponds to a faster kinetics of hydrogen evolution.

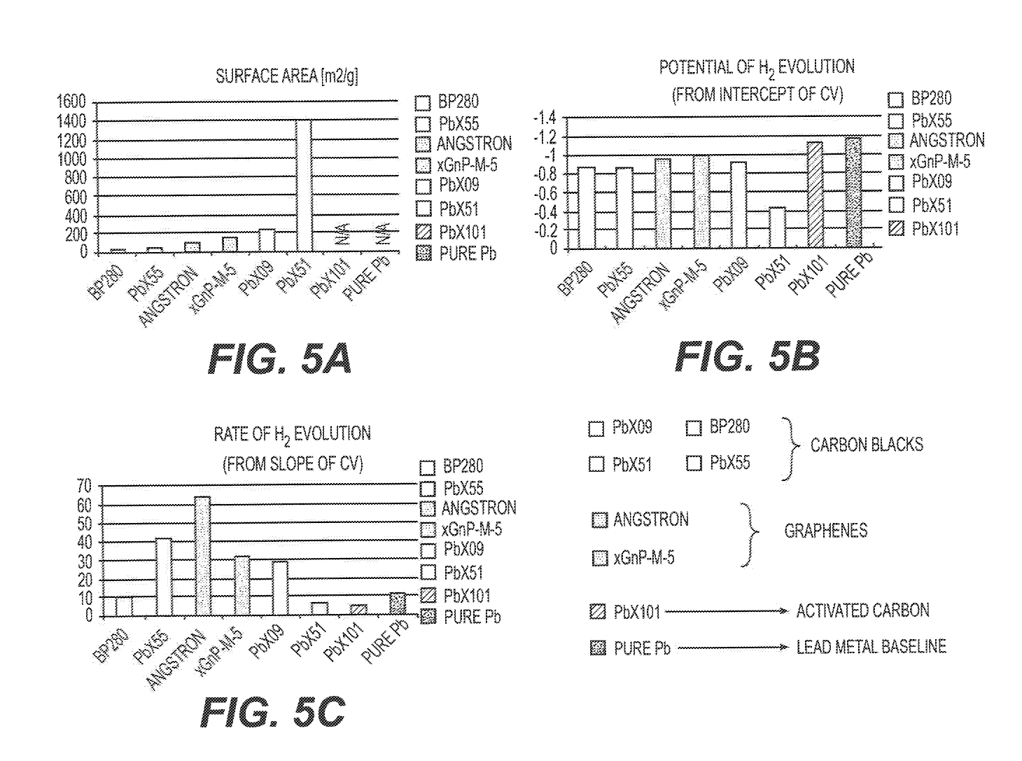

According to FIGS. 4a-4c, it can also be seen that the type of carbon may influence the rate of hydrogen evolution. A carbon material having a higher surface area provides a lower operating current density. Hence it may be desirable to select a carbon material with a high surface area and low hydrogen overpotential. FIGS. 5a-5c illustrate comparisons of the surface areas, potentials of hydrogen evaluation, and rates of hydrogen evolution associated with the carbon materials used in the various embodiments of this disclosure.

While all carbon additives tested are capable of increasing the electrical conductivity of the active mass by percolation phenomena, it has been reported that their effectiveness dies out quickly above a quantity of 2-4% wt of the active material. Without wishing to be bound by theory, the present inventors believe that the reason for this may be a function of the type of carbon rather than the conductivity of the carbon being lower than that of the metal itself. Capacitance is believed to play a major role in limiting carbon's effectiveness. It is also possible that excessive amounts of carbon can make the hydrogen evolution reaction dominant, thus, limiting the charge acceptance of the active material. The carbon contribution to electrical conductivity may be important when the level of sulfates in the active material increases above a certain threshold that negatively affects the power performance. This phenomenon is commonly seen in the HRPSOC regimens associated with hybrid vehicles applications.

According to an embodiment, high surface-area carbons, e.g., carbon blacks with a surface area of over 1,500 m²/g, may provide extra nucleation sites for sulfate crystals, thereby restricting their growth and limiting their size during HRPSOC. These carbon materials also exercise a steric effect that limits the growth of large sulfate crystals by making unfavorable the thermodynamics of their growth. They also contribute to the capacitance of the negative active mass. Thus, it is desirable to use a material with a relatively higher surface area and a relatively lower content of contaminant.

According to an embodiment, the onset of hydrogen evolution may be considered a marker for better kinetics. And the slope of hydrogen evolution may be considered a reinforcing parameter. Based on these parameters, the inventors of this disclosure have identified the PbX 51 carbon (“PbX51” hereinafter) listed in Table 1 as an exemplary material for improving charge acceptance of lead-acid batteries.

The inventors of this disclosure believe that carbon may improve charge acceptance of lead acid batteries for the following reasons:

Carbon gives higher conductivity at PSOC;

Carbon increases the capacitance of the negative electrode;

Carbon provides protective coating on the lead sulfate crystals thus preventing them from growing into large crystals; and

Carbon nucleates smaller lead sulfate crystal growth;

The inventors also believe that the lead sulfate reduction provided by carbon is chemically driven and not just an electrochemical process. The reducing agent here is the “nascent hydrogen” or atomic hydrogen at the surface of the carbon. This atomic hydrogen production is the first step in the electrochemical water discharge reaction, presented by formulas 1 and 2 below.

2C+H₂O+2e⇄2C . . . H+(OH)⁻ (1)

2C . . . H+PbSO₄⇄2C+Pb+H₂SO₄+2e (2)

The higher the hydrogen overpotential (i.e., less negative or closer to zero Volt), the easier it is for the water discharge reaction to take place and the easier it will be for the reduction of lead sulfate. Thus the carbon materials that show a less negative hydrogen overpotential have a better lead sulfate reduction rate.

According to an embodiment, two methods may be used to validate and verify this hypothesis:

1. A platinized carbon electrode may be used instead of pure carbon. Since hydrogen evolution is expected to be highly favored on Pt substrates, the charge acceptance may also be improved; or

2. Adding a hydrogen evolution poison to the electrolyte, i.e., an “electrode poison ion,” which once adsorbed at the surface of the carbon prevents the atomic hydrogen from recombining. Formulas 3 and 4 below represent the chemical process without the electrode poison and the chemical process with the poison, respectively.

M . . . H+M . . . H→2M+H₂(without electrode poison) (3)

M . . . H+(Poison)M . . . H→M . . . H+M . . . H (4)

As a result, the coverage of atomic hydrogen at the surface may increase, along with the dwell time and with it the rate of sulfate reduction.

High surface-area carbons having particle sizes of 10-20 nm, when used in the electrodes, may enhance DCA of lead-acid batteries. In one embodiment, the surface area of the carbon additive may be at least about 750 m²/g. In a further embodiment, the surface area of the carbon additive may be at least about 1,500 m²/g. Further enhancements may also be achieved by creating a mixture or a matrix of particle size distributions including a combination of small and large particle sizes.

In a further embodiment, the DCA of negative active materials may be improved by optimizing the particle size distribution by combining large particles with small particles having high surface area. In a further or alternative embodiment, the carbon content may be at least 1% by weight of the negative active material of the electrode. In a further or alternative embodiment, the carbon content may be greater than 3% of the negative active material by weight. In a further embodiment, the carbon content may be increased to up to 20-25% of the negative active material by weight to enhance the capacitance performance. In a still further or alternative embodiment, the carbon content may be less than 30% of the negative active material by weight. In a still further or alternative embodiment, carbon structures that are compatible with hydrogen evolution (e.g., PbX51 discussed above) may be used in the negative active materials.

Table 2 lists embodiments of this disclosure tested for DCA performance at 25° C. under different testing protocols.

TABLE 2

| | Testing Protocol |
|---|---|
| Embodiment #1 | 2C/2C - 100% DoD - 25° C. |
| Embodiment #2 | 2C/2C - 80% DoD - 25° C. |
| Embodiment #3 | 2C/2C - 40% DoD - 25° C. |
| Embodiment #4 | 2C/2C - 50 ± 20% SoC - 25° C. |

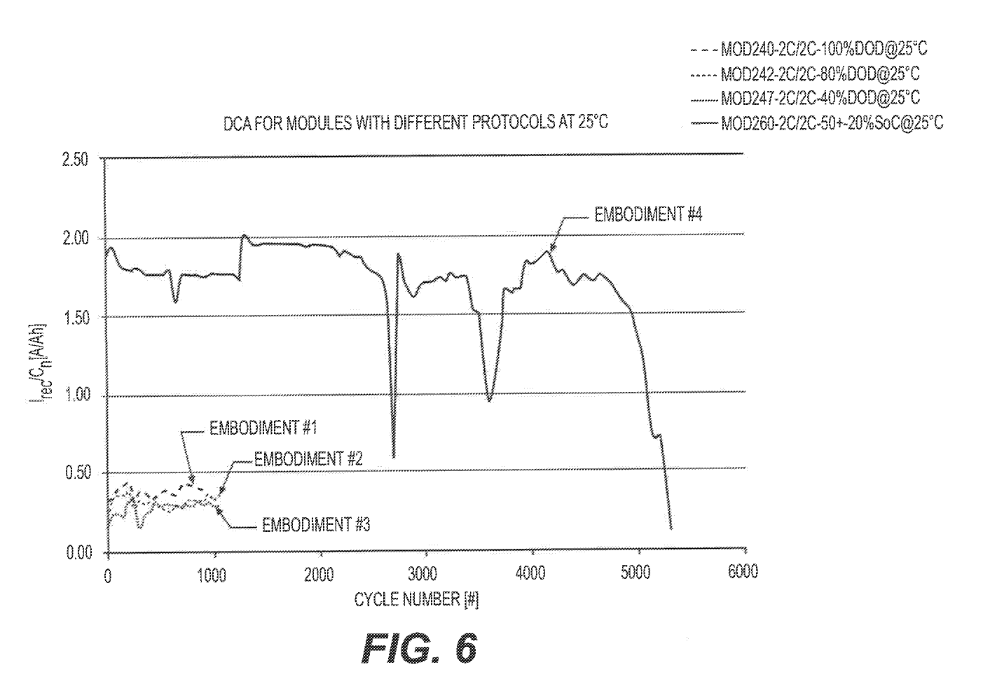

FIG. 6 illustrates the testing results showing the DCA performance of the embodiments listed in Table 2. As shown in FIG. 6, DCA values are highly dependent on the state of charge of a battery and the testing regimen.

Table 3 lists additional embodiments of this disclosure tested for DCA performance at 41° C. under different testing protocols.

TABLE 3

| | Testing Protocol |
|---|---|
| Embodiment #5 | 2C/2C - 100% DoD - 41° C. |
| Embodiment #6 | 2C/2C - 80% DoD - 41° C. |
| Embodiment #7 | 2C/2C - 40% DoD - 41° C. |

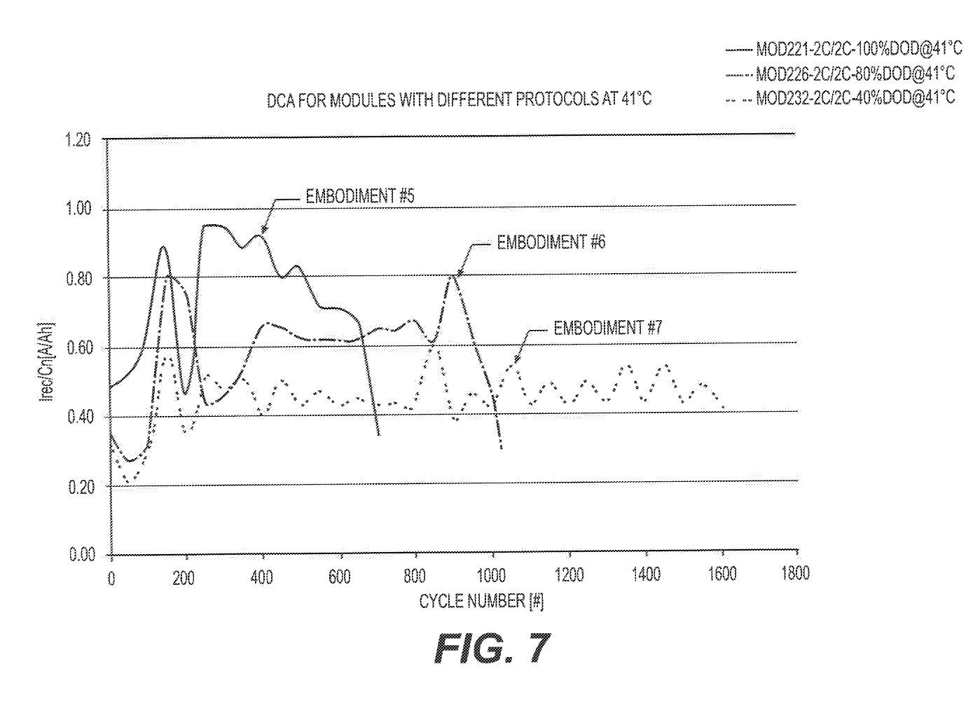

As shown in FIG. 7, DCA values are relatively higher at 41° C. compared with those at 25° C., in FIG. 6.

Table 4 lists additional embodiments of this disclosure tested for DCA performance under different compression levels relative to a free standing stack of electrodes and separators.

TABLE 4

| | Testing Protocol | Compression Level |
|---|---|---|
| Embodiment #8 | 2C/2C - 100% DoD - 25° C. | 0% Compression |
| Embodiment #9 | 2C/2C - 100% DoD - 25° C. | 50% Compression |
| Embodiment #10 | 2C/2C - 100% DoD - 25° C. | 30% Compression |

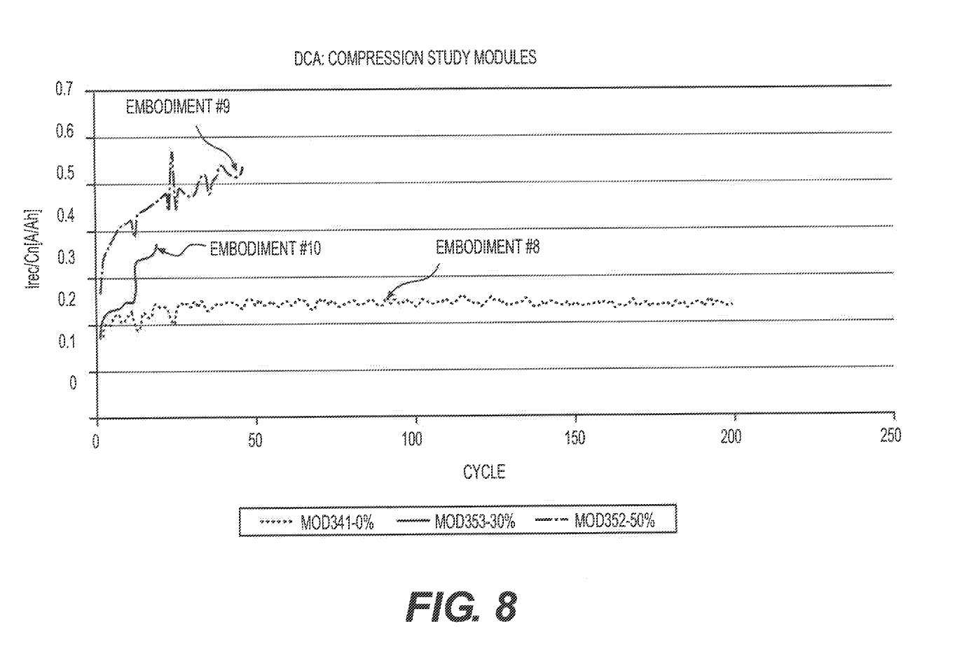

As shown in FIG. 8, DCA values are relatively higher at higher compression levels.

Table 5 lists additional embodiments of the disclosure tested for DCA performance with relatively higher acid fills, in which a battery was refilled with acid after all the electrode pores were made available by the completion of the formation processes.

TABLE 5

| | Testing Protocol | Demographics |
|---|---|---|
| Embodiment #11 | 2C/2C - 100% DoD - 25° C. | 2^{nd} Acid Fill |
| Embodiment #12 | 2C/2C - 100% DoD - 25° C. | 2^{nd} Acid Fill |
| Embodiment #13 | 2C/2C - 100% DoD - 25° C. | 2^{nd} Acid Fill |

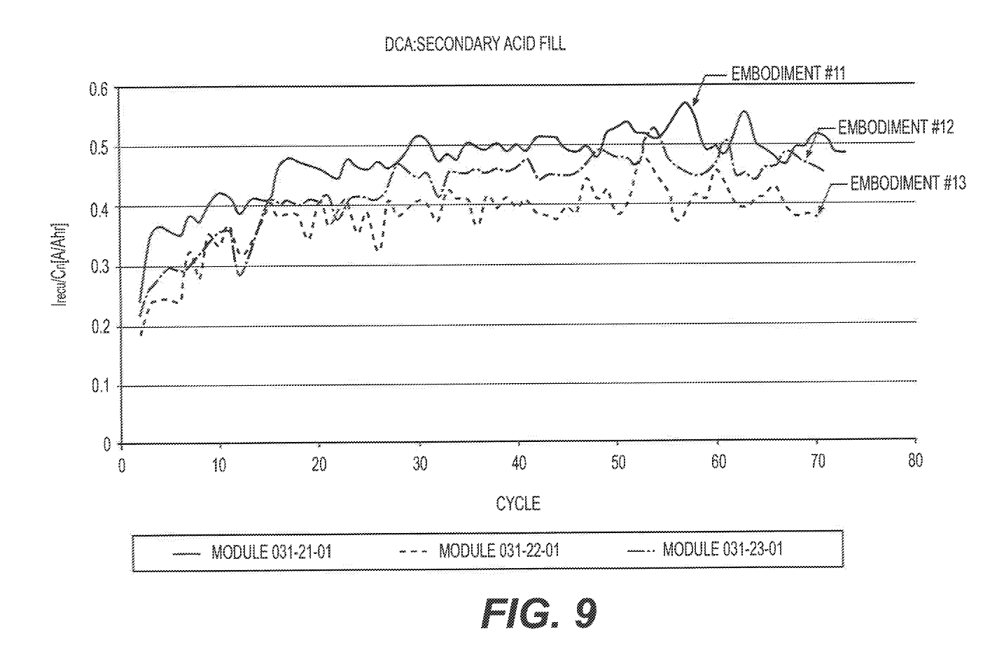

As shown in FIG. 9, DCA values are relatively higher with second acid fill compared with batteries without second acid fill.

Table 6 lists additional embodiments of the disclosure tested for DCA performance under the SBA cycling protocol, which is a standard developed by the Battery Association of Japan to determine the cycle life of lead acid batteries for use in vehicles with idling stop-start systems. The SBA cycling protocol is defined in the Battery Association of Japan Standard, SBA S 0101:2006, which is incorporated by reference in its entirety.

TABLE 6

| | Testing Protocol | Demographics |
|---|---|---|
| Embodiment #14 | SBA - 25° C. | Gen-1 (control) |
| Embodiment #15 | SBA - 25° C. | Gen-1 (control) |
| Embodiment #16 | SBA - 25° C. | 3.0 NAM (w/carbon |
| | | black) |
| Embodiment #17 | SBA - 25° C. | 3.0 NAM (w/carbon |
| | | black) |
| Embodiment #18 | SBA - 25° C. | 3.0 NAM (w/carbon |
| | | black) |
| Embodiment #19 | SBA - 25° C. | 3.0 NAM (w/carbon |
| | | black) |

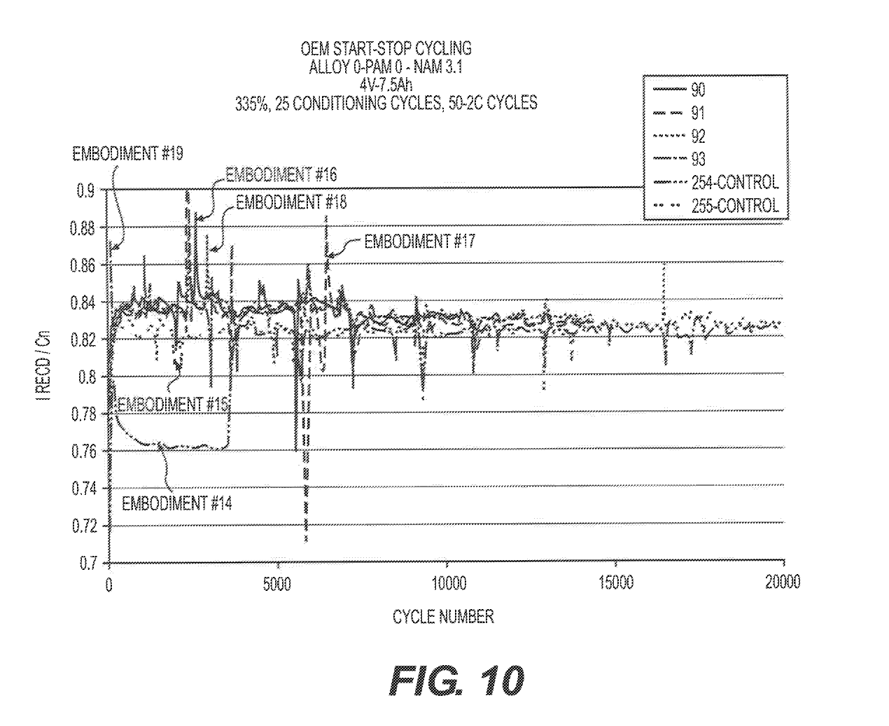

FIG. 10 shows that DCA values are higher with 3.0 NAM, a carbon-black enhanced negative active material.

According to the above-disclosed embodiments, DCAs of embodiment #4 is much higher than DCAs of the other embodiments analyzed above. The above-disclosed tests show that the DCA of lead-acid battery is affected by the testing protocol. In addition, DCA increases when SOC becomes lower, when higher temperature become higher, when secondary acid fill is performed, or when compression amount is increased.

According to an embodiment, tests were conducted to compare the charge acceptance performance of a lead-acid battery with a conventional negative active material (NAM) having a conventional form of carbon (e.g., graphite) and a lead-acid battery with a negative active material (NAM) having the Pbx51 carbon additive identified above. For ease of references, “NAM 0.0” hereinafter refers to the conventional lead-acid battery with the conventional negative active material, and “NAM 51” hereinafter refers to the lead-acid battery with the negative active material having the Pbx51 carbon additive. As described above, Pbx51 is a carbon black with high surface area, less negative hydrogen over-potential, and low rate of hydrogen evolution. Except for the Pbx51, other components in the NAM 0.0 battery and the NAM 51 battery are the same.

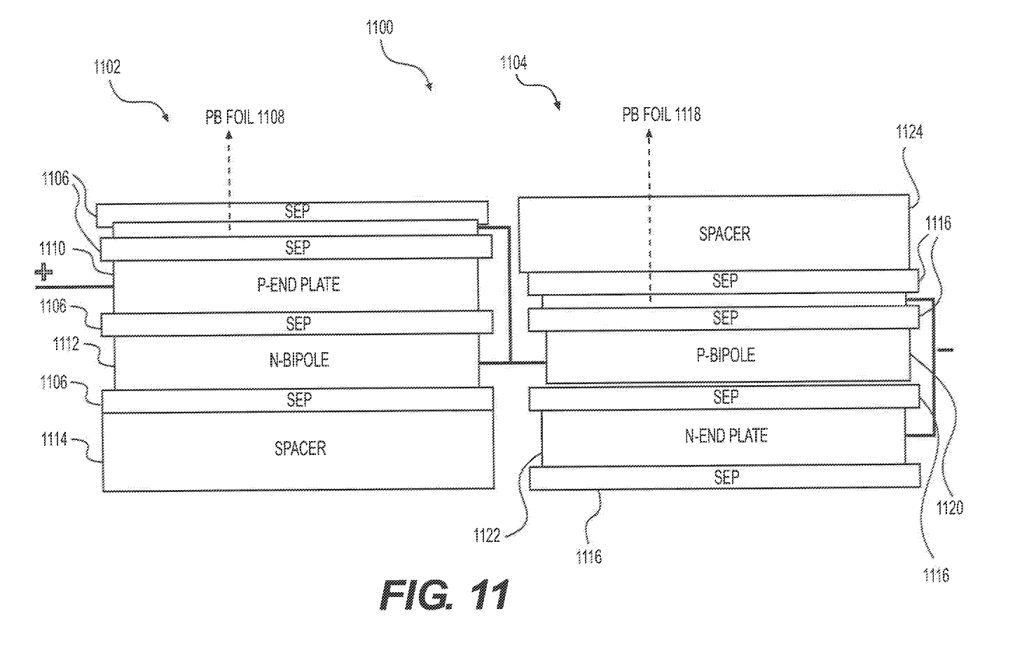

The NAM 0.0 battery and the NAM 51 battery each include 5 cells, although less or more cells may also be included. FIG. 11 illustrates the structure of a cell 1100 used in both NAM 0.0 and NAM 51. Each cell 1100 includes a first unit 1102 and a second unit 1104. First unit 1102 includes a plurality of separators 1106 separating a Pb foil 1108, a positive end plate 1110, and a negative bipole plate 1112. Negative bipole plate 1112 is disposed on a spacer 1114 through one of separators 1106. Second unit 1104 also includes a plurality of separators 1116 separating a Pb foil 1118, a positive bipole plate 1120, and a negative plate 1122. Pb foil 1118 is disposed on a spacer 1124 through one of separators 1116. Positive bipole plate 1120 of second unit 1104 is electrically coupled to negative bipole plate 1112 and Pb foil 1108 of first unit 1102. Positive end plate 1110 of first unit 1102 provides a positive terminal for connecting with other cells or circuits. Negative end plate 1122 and Pb foil 1118 of second unit are coupled together to provide a negative terminal for connecting with other cells or circuits. Pb foil 1108 and negative bipole plate 1112 of first unit 1102 are coupled together and electronically connected with positive bipole plate 1120 of second unit 1104.

In an embodiment, the cells for NAM 0.0 and NAM 51 are formed and treated according to a standard protocol including 335% formation and four C/2 conditioning cycles. After the conditioning cycles, nominal capacity of these cells is about 2 Ah at a C/10 rate.

Each battery was subject to the following test method including:

Step 1: charging at C/2 rate up to 4.9 V;

Step 2: charging at C/10 rate up to 4.9 V or 105% of Nominal Capacity;

Step 3: discharging at 1C rate to a specific state of charge (e.g., 20%, 40%, 60%, and 80%);

Step 4: resting for 30 minutes; and

Step 5: charging at 4.95 V for 10 minutes.

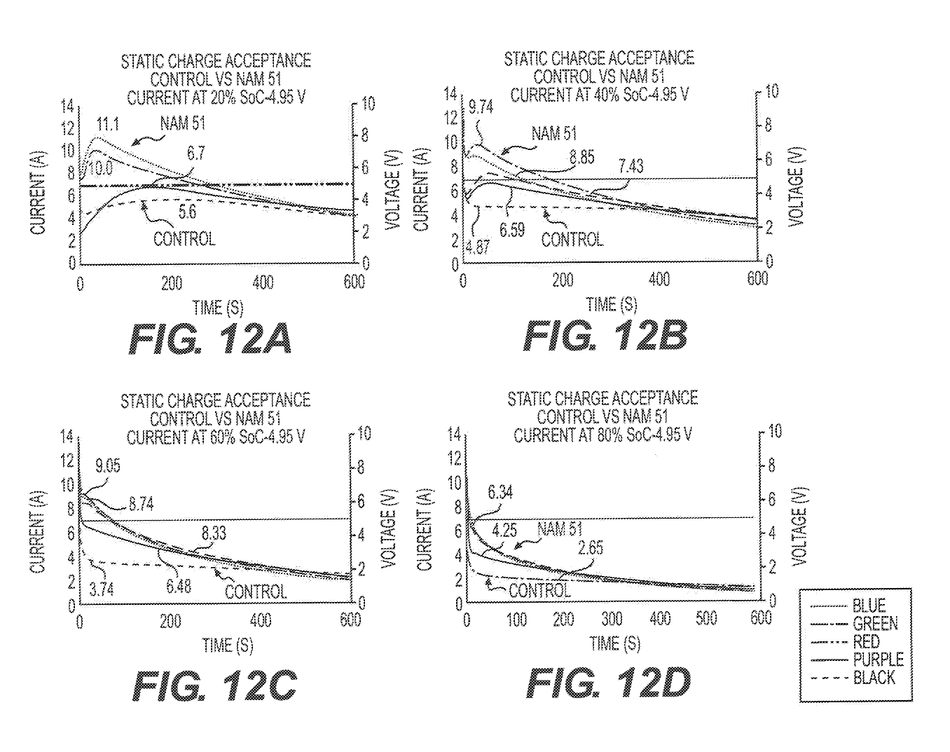

The analysis metrics include the maximum current and the charge input, which may be measured during Step 5 above. FIGS. 12-15 illustrate the test results showing comparisons between the NAM 0.0 battery (i.e., the control) and the NAM 51 battery. FIG. 12(a)-(c) show the change of charge current (A) as a function of time (s) for SOC of 20%, 40%, 60%, and 80%, respectively, during the 10-minute charge time in Step 5 above. The charge current of NAM 51 remains greater than the charge current of NAM 0.0 until the batteries are almost fully charged.

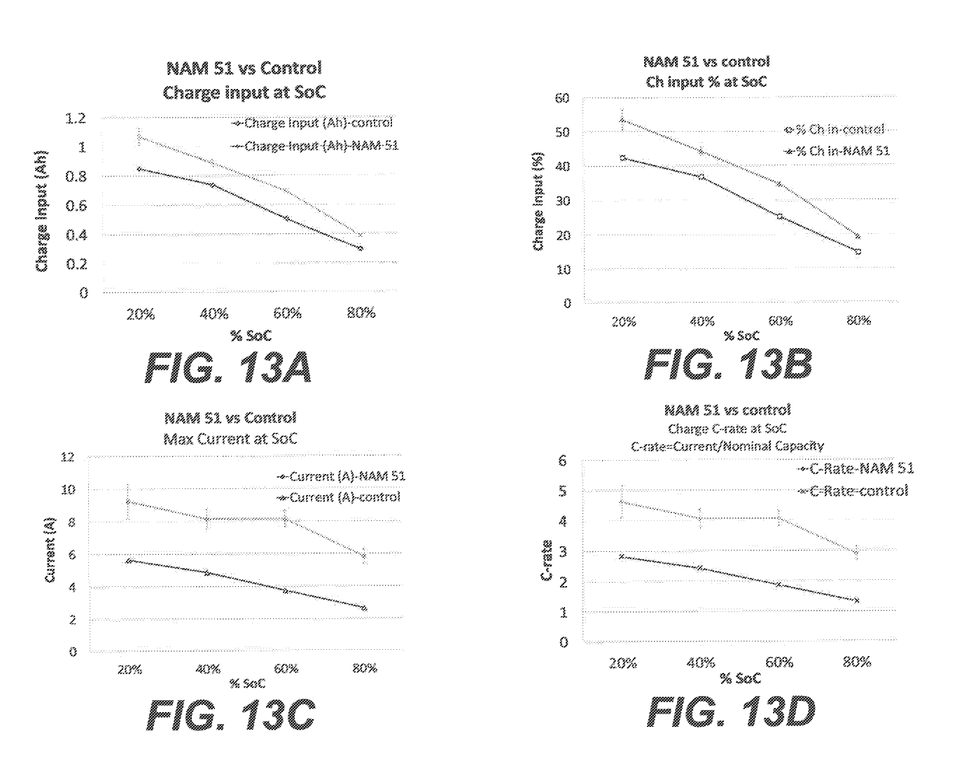

FIG. 13(a) illustrates comparisons of charge input (Ah) of NAM 0.0 and NAM 51 for different SOCs during the 10-minute charge time in Step 5 above. FIG. 13(b) illustrates comparisons of charge input (in percentage) of NAM 0.0 and NAM 51 for different SOCs during the 10-minute charge time in Step 5 above. FIG. 13(c) illustrates comparisons of maximum charge current of NAM 0.0 and NAM 51 for different SOCs during the 10-minute charge time in Step 5 above. FIG. 13(d) illustrates comparisons of charge C rate for different SOCs during the 10-minute charge time in Step 5 above. As shown in FIGS. 13(a)-13(d), compared with NAM 0.0, NAM 51 may achieve greater charge input (in both Ah and percentage), greater maximum charge current, and greater C rate.

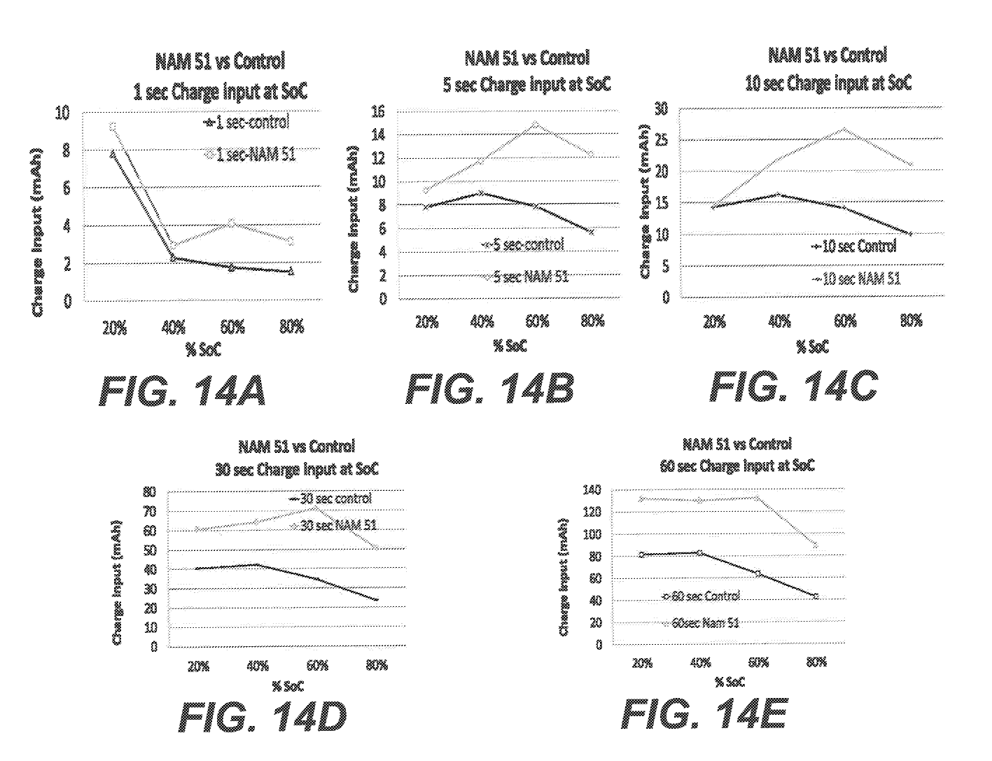

FIGS. 14(a)-(e) illustrate the comparisons of charge input (mAh) for various SOCs and various charge intervals. The charge input is measured after the batteries are charged for 1 second (FIG. 14(a)), 5 seconds (FIG. 14(b)), 10 seconds (FIG. 14(c)), 30 seconds (FIG. 14(d)), and 60 seconds (FIG. 14(e)). As shown in these figures, charge input is greater for NAM 51 than NAM 0.0 in all charge intervals and all SOCs during the charge in Step 5.

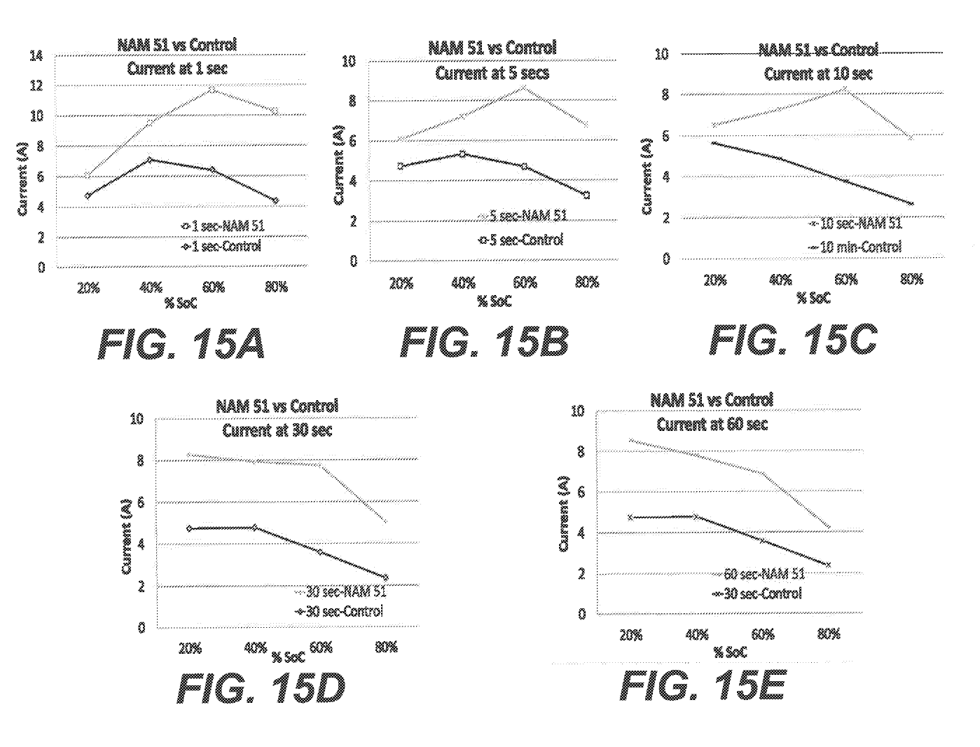

FIGS. 15(a)-(e) illustrate the comparisons of charge current (A) for NAM 0.0 and NAM 51 at various times during the charge in Step 5. The charge current is measured at 1 second (FIG. 15(a)), 5 seconds (FIG. 15(b)), 10 seconds (FIG. 15(c)), 30 seconds (FIG. 15(d)), and 60 seconds (FIG. 15(e)) after charge starts in Step 5. As shown in these figures, charge current for NAM 51 is greater than NAM 0.0 at all times.

Table 7 below summarizes the comparisons between NAM 0.0 and NMA 51 illustrated in FIGS. 12-15 discussed above.

TABLE 7

| | | Charge Input | | | |
|---|---|---|---|---|---|
| SOC | Paste | (Ah) | % Charge in | Current (A) | C-Rate |
| 20% | NAM 51 | 1.07 ± 0.06 | 54 ± 3 | 9.3 ± 1.1 | 4.6 ± 0.5 |
| | NAM 0.0 | 0.85 | 42 | 5.6 | 2.8 |
| 40% | NAM 51 | 0.89 ± 0.02 | 44 ± 1 | 8 ± 1 | 4.1 ± 0.3 |
| | NAM 0.0 | 0.74 | 37 | 4.87 | 2.4 |
| 60% | NAM 51 | 0.69 ± 0.01 | 35 | 8 | 4.1 ± 0.2 |
| | NAM 0.0 | 0.50 | 25 | 3.74 | 1.9 |
| 80% | NAM 51 | 0.39 | 19 | 6 | 2.9 ± 0.2 |
| | NAM 0.0 | 0.29 | 15 | 2.65 | 1.3 |

As Table 7 above shows, the NAM 51 battery achieved consistently higher charge acceptance than the NAM 0.0 battery. In particular, at 20% state of charge (SOC), the NAM 51 battery received charge input 20%-35% greater than the NAM 0.0 battery. Charge current in the NAM 51 battery is 30%-60% greater than the NAM 0.0 battery. At 40% state of charge, the NAM 51 battery received charge input 17%-24% greater than the NAM 0.0 battery. Charge current in the NAM 51 battery is 55%-80% greater than the NAM 0.0 battery. At 60% state of charge, the NAM 51 battery received charge input 35%-41% greater than the NAM 0.0 battery. Charge current in the NAM 51 battery is 105%-131% greater than the NAM 0.0 battery. At 80% state of charge, the NAM 51 battery received charge input 30%-33% greater than the NAM 0.0 battery. Charge current in the NAM 51 battery is 102%-137% greater than the NAM 0.0 battery.

In an embodiment, the hybrid pulse-power capability (HPPC) test is conducted on the NAM 0.0 and NAM 51 batteries to compare charge and discharge resistances at various depths of discharge (DODs) including, for example, 20% DOD, 40% DOD, 60% DOD, and 80% DOD. The HPPC test includes the following steps:

Step 1: discharging at 1C rate (nominal);

Step 2: charging at 1C rate (nominal) followed by constant voltage roll off;

Step 3: resting for 1 hours;

Step 4: discharging by 10% depth of discharge;

Step 5: resting for 1 hour after discharging;

Step 6: discharging pulse at 5C rate for 10 seconds or voltage below 1.2 V/cell;

Step 7: resting for 40 seconds;

Step 8: charging pulse at 5C rate for 10 seconds or voltage lid of 1.66 V/cell; and

Step 9: repeating Steps 4-7 for 9 times.

Discharge and charge resistances were obtained based on the voltage ΔV and current ΔI values measured during above Step 5 and Step 8, respectively, according to the following formula:

R=ΔV/ΔI.

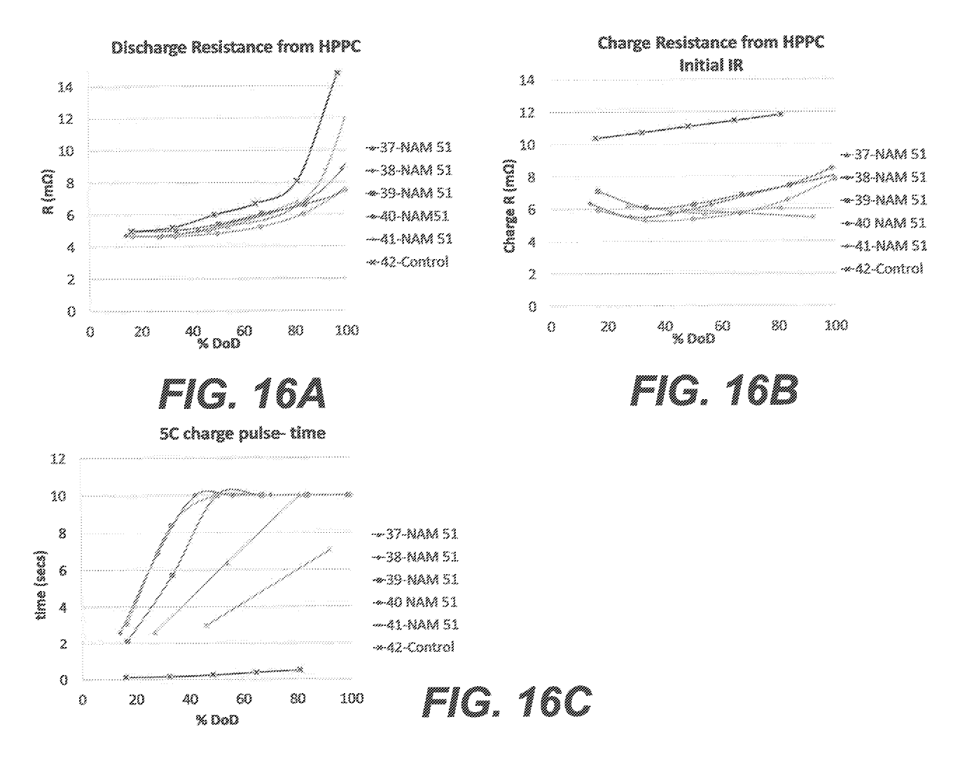

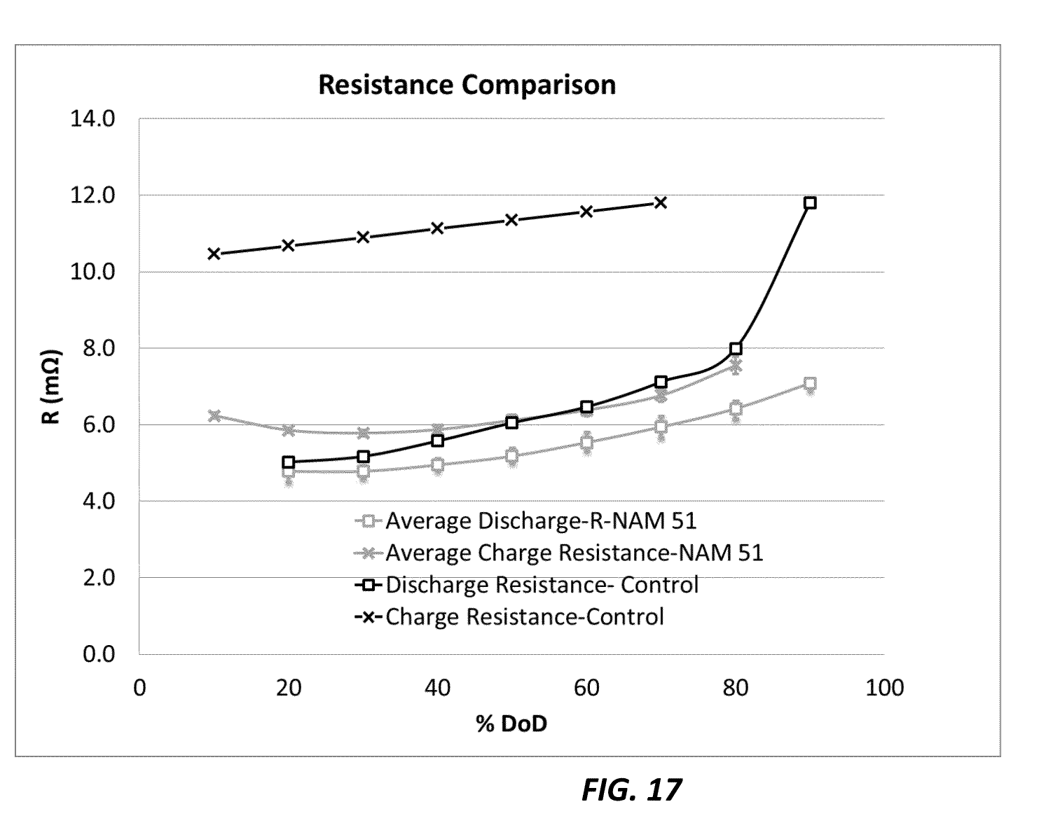

FIGS. 16 and 17 illustrate comparisons between the NAM 0.0 and NAM 51 batteries based on the HPPC test results. According to the HPPC test results, the NAM 51 battery has better performance than the NAM 0.0 battery. As shown in FIG. 16(a), the NAM 51 battery has lower discharge resistance than the NAM 0.0 battery at all DODs. According to FIG. 17, the average discharge resistance of the NAM 51 battery is 4-40% lower than the NAM 0.0 battery, depending on the specific depth of charge. As shown in FIG. 16(b), the NAM 51 battery has lower charge resistance than the NAM 0.0 battery at all DODs. According to FIG. 17, the average charge resistance of the NAM 51 battery is 40-47% lower than the NAM 0.0 battery, depending on the specific depth of charge. As shown in FIG. 16(c), the NAM 0.0 battery could not sustain the 5C charge pulse for more than 0.5 second at any depth of discharge. The NAM 51 battery, on the other hand, could sustain the 5C charge pulse for 10 seconds at depth of charge greater than 40%.

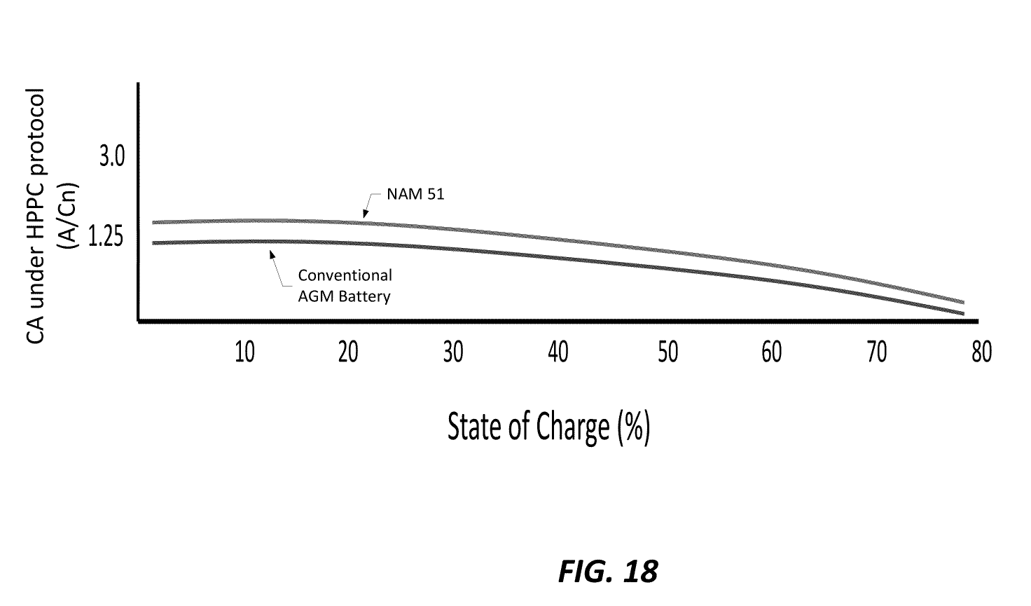

According to an embodiment, the charge acceptance of a battery may be determined for all state of charge according to the HPPC testing protocol. As shown in FIG. 18, the NAM 51 may achieve greater charge acceptance than a conventional AGM battery within the entire range of SOC.

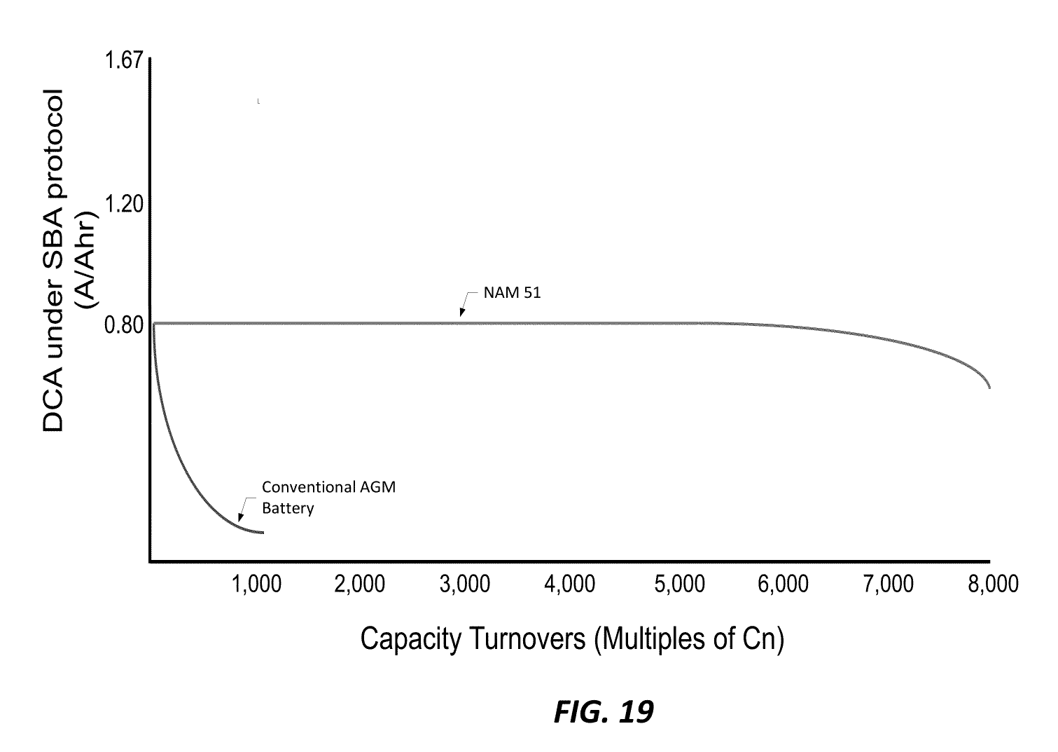

According to an embodiment, the charge acceptance of a battery may also be determined according to the SBA testing protocol for various numbers of capacity turnovers. As shown in FIG. 19, the charge acceptance of the conventional AGM battery quickly declined to a significantly low value after about 1000 cycles. The charge acceptance of NAM 51, however, remained a substantially constant high value for over 6000 cycles and only declined slightly above 6000 cycles.

It will be apparent to persons of ordinary skill that variations and modifications may be made in the use of carbon to improve charge acceptance without departing from the scope of the appended claims or their equivalents. The present inventors do not intend to restrict the invention to the particular carbon blacks, activated carbons, or graphitic carbons described above. Rather, it is intended that these variations and modifications in the form of the carbon used be considered part of the invention, provided they come within the scope of the appended claims and their equivalents.

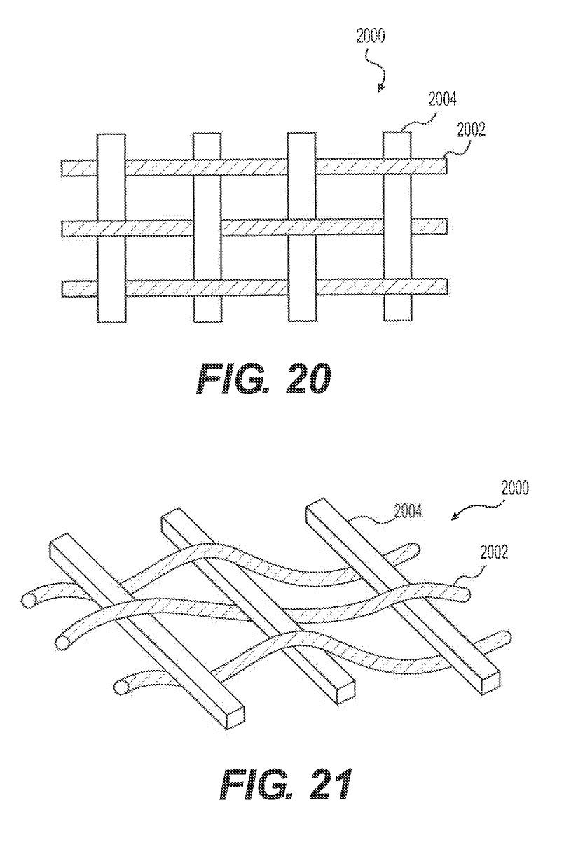

For example, FIGS. 20 and 21 illustrate a cross-wire structure 2000 including carbon material disclosed above, according to an embodiment. Cross-wire structure 2000 includes a set of lead wires 2002 and a set of carbon wire 2004. Lead wires 2002 may be arranged in a parallel fashion. Carbon wires 2004 may also be arranged in a parallel fashion, crossing lead wires 2002. Carbon wires 2004 and lead wires 2002 may then be woven with each other to form cross-wire structure 2000. Carbon wires 2004 may include high capacitance carbon felt wire, carbon tape, or composite carbon. Cross-wire structure 2000 may be incorporated in a negative electrode and/or a positive electrode of a lead-acid battery. Carbon wires 2004 may provide enhanced charge acceptance performance of the lead-acid battery consistent with the embodiments disclosed above.

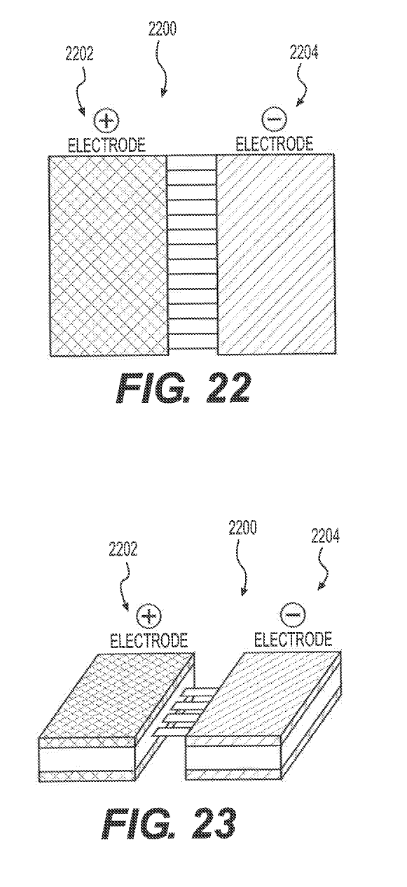

FIGS. 22 and 24 illustrate a lead-acid cell 2200 having a positive electrode 2202 and a negative electrode 2204, according to an embodiment. Negative electrode 2204 may include pasting paper having carbon material disclosed above. The carbon in the pasting paper may be made from carbon felt, carbon tape, or any other carbon material treated for enhancing capacitance. Positive electrode 2202 may include glass pasting paper or carbon-based pasting paper similar to that in negative electrode 2204. The carbon-based pasting paper may provide enhanced charge acceptance performance of the lead-acid battery consistent with the embodiments disclosed above.

According to a further embodiment, negative electrode 2204 includes a carbon fiber needle milled PAN fiber veil. The PAN veil is pretreated with a plasma arc to activate the carbon material with a high surface area for increased dynamic charge acceptance. Strips of surface activated carbon veil are rolled onto both sides of a pasted bipolar plate to form the negative electrode. This embodiment provides a direct replacement for non-active AGM and the glass fiber pasting paper in the conventional lead-acid batteries, while providing enhanced charge acceptance performance. Alternatively, this embodiment may be used as an under layer or as a carrier for more fragile PAN SACV applications and provide enhanced charge acceptance performance.

According to another embodiment, the positive electrode and/or negative electrode may each include a substrate or grid coated with carbon particle paste. The carbon particle paste may include carbon material disclosed above. The carbon-coated substrate may provide enhanced charge acceptance performance of the lead-acid battery consistent with the embodiments disclosed above.

Other embodiments of the invention will be apparent to those skilled in the art from consideration of the specification and practice of the invention disclosed herein. For example, carbon additive other than PbX51 may be introduced to the negative active material or the positive active material to improve the charge acceptance and to achieve comparable results as discussed above. It is intended that the specification and examples be considered as exemplary only, with a true scope and spirit of the invention being indicated by the following claims.

What is claimed is:

1. A negative electrode of a lead-acid battery, comprising:
active material comprising lead; and
a carbon additive configured to increase a charge input of the lead-acid battery by at least 17%, relative to a negative electrode without the carbon additive.

2. The negative electrode of claim 1, wherein the carbon additive is configured to increase the charge input by 20-35% at 20% state of charge.

3. The negative electrode of claim 1, wherein the carbon additive is configured to increase the charge input by 17-24% at 40% state of charge.

4. The negative electrode of claim 1, wherein the carbon additive is configured to increase the charge input by 35-41% at 60% state of charge.

5. The negative electrode of claim 1, wherein the carbon additive is configured to increase the charge input by 30-33% at 80% state of charge.

6. The negative electrode of claim 1, wherein the carbon additive is further configured to decrease an average discharge resistance of the lead-acid battery by at least 4%.

7. The negative electrode of claim 6, wherein the average discharge resistance is calculated based on voltages and currents measured at a group of depths of discharge including at least one of 20%, 40%, 60%, or 80%.

8. The negative electrode of claim 1, wherein the carbon additive is further configured to decrease an average charge resistance of the lead-acid battery by at least 40%.

9. The negative electrode of claim 8, wherein the average charge resistance is calculated based on voltages and current measures at a group of depths of discharge including at least one of 20%, 40%, 60%, or 80%.

10. The negative electrode of claim 1, wherein the carbon additive includes at least one of carbon black, activated carbon, or graphitic carbon.

11. The negative electrode of claim 1, wherein the carbon additive includes at least one of graphene, carbon nanotubes, fullerenes, double walled carbon nanotubes, carbon fibers, carbon felt, meso-carbon microbeads (MCMB), carbon cones, carbon needles, carbon platelets, carbon nano-belts, or carbon nano-wires.

12. The negative electrode of claim 10, wherein the carbon additive includes PbX51 carbon.

13. The negative electrode of claim 1, wherein the carbon additive includes a plurality of particles.

14. The negative electrode of claim 13, wherein the particles have specific surface area of at least 750 m²/g.

15. The negative electrode of claim 13, wherein the particles having sizes of about 10-20 nm.

16. The negative electrode of claim 15, wherein the sizes of the particles include more than one distribution.

17. A negative electrode of a lead-acid battery, comprising:
active material comprising lead; and
a carbon additive of at least 1% in weight of the active material.

18. The negative electrode of claim 17, wherein the carbon additive is between 20% to 25% of the active material in weight

19. The negative electrode of claim 17, wherein the carbon additive is integrated in a cross-wire structure or pasting paper of the negative electrode.

20. A lead-acid battery, comprising:
a positive electrode; and
a negative electrode, wherein the negative electrode comprising:
active material further comprising lead; and
a carbon additive of at least 1% of the active material in weight.

21. The lead-acid battery of claim 20, wherein the battery is used in a vehicle.

22. The lead-acid battery of claim 20, wherein an output of the battery remains above 1.2 V/cell at a 5C rate for at least 10 seconds.

23. The lead-acid battery of claim 22, wherein the battery has a depth of discharge of at least 40%.

24. The lead-acid battery of claim 20, wherein a charge acceptance of the battery remains substantially constant between 0 and about 6000 capacity turnovers.
